(19) United States
(12) Patent Application Publication
(10) Pub. No.: US 2004/0167749 A1
(43) Pub. Date: Aug. 26, 2004

(54) Interface and method for testing a website

(76) Inventors: Richard Friedman, Cherry Hill, NJ (US); Jason Kinner, Marlton, NJ (US); Joseph J. Snyder, Shamong, NJ (US); Gregory Pavlik, Shamong, NJ (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/372,456

(22) Filed: Feb. 21, 2003

(51) Int. Cl. G06F 19/00

(52) U.S. Cl. 702/186

(57) ABSTRACT

A website test system includes an interface and a test engine. The interface receives a test specification encoded in an extensible markup language. The interface forwards the test specification to the test engine, which receives the test specification, identifies a source code of interest, establishes a communication session with a server hosting the source code of interest, and evaluates the source code in accordance with the test specification.

### BACKGROUND

The Internet is a world-wide collection of computing devices, networks, and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, government, educational, and other computer systems that route data packets from node to node across the various networks.

The World Wide Web (WWW), or web, refers to the total set of interlinked hypertext documents residing on hypertext transfer protocol (HTTP) servers all around the world. Documents on the web, called pages or web pages, are written in hypertext mark-up language (HTML), identified by uniform-resource locators (URLs) that identify the particular machine and pathname by which a file can be accessed and transmitted from node to node to the end user using HTTP. HTML-based pages contain standard text as well as formatting codes that indicate how the page should be displayed. A web site is a related group of these documents, associated files, scripts, subprocedures, databases, application software, etc. that are provided by an HTTP server coupled to one of the various networks. Web sites are accessible via a uniform resource locator (URL).

A URL is a global address of documents and other resources on the web. The first part of the address indicates what protocol to use, and the second part specifies the Internet protocol address or the domain name where the resource is located. For example, the two URLs below point to two different files at the domain “pcwebopedia.com.” The first specifies an executable file that can be fetched from a server using the File Transfer Protocol (FTP); the second specifies a web page that can be fetched from a web server using HTTP.

ftp://www.pcwebopedia.com/stuff.exe

http://www.pcwebopedia.com/index.html

The ubiquitous nature of the Internet has led to the proliferation of various data types on the Internet. Furthermore, web page content is often highly dynamic in nature with integration of the various data types often performed in an automated fashion. While updating web content, scripts, applications, and other web components automatically may be advantageous, and in most situations the only practical way to integrate the volume of information within a useful timeframe, automatic updating of web content and web components often results in errors. These errors can include, but are not limited to, web page syntax errors, data format errors, link reference errors, etc.

Due to the vast number of resources serving web pages on the Internet, various automated test products have been developed that facilitate automated web site testing. HttpUnit is one such test product. HttpUnit enables web site verification and analysis without using a web browser. HttpUnit is an open-source application programming interface (API) that emulates browser behavior pursuant to evaluating web site content and components.

Hypertext markup language (HTML) is a scripting language used on the Internet. A web page constructed using HTML comprises text with accompanying “markups” that define text formats, such as, heading style, as well as image location, and links among other web page information. A link is a reference from one point in a page to another point in the same document or to a point in another document. A link may reference a point in a document located externally from the source document. That is, a link may reference a document or location within a document located on another web server.

Computing devices use a client application program generally called a “web browser” and a communication link to the Internet to access a web site active on a web server. Web browsers are software applications that locate, request, receive, and display content stored within a specific device coupled to the Internet. Web browsers display graphics including text. In addition, when web browsers receive data via a high-speed data link, they can receive and process data-rich media, such as moving pictures and sound.

Web browsers also enable a user to navigate the Internet or a proprietary Intranet that uses transmission control protocol and Internet protocol (TCP/IP), to view HTML files stored on a network-connected device, view data stored on another network, access data stored on a user's computing device, and/or access data on other data-storage devices. The user can navigate the Internet by entering a URL in an address-entry field provided by the browser or selecting a “link” embedded in a displayed representation of a HTML file. The user can navigate network-coupled devices by entering appropriate paths in the address-entry field. Once the user has located desired web content (e.g., a sound file, a movie clip, a folder on a data-storage device, or a file-of-interest), the user can enter a command to retrieve and process the web content. When the web content is a HTML file, the web browser displays the file like any other web page. When the web content is associated with an application program (e.g., a spreadsheet file, generated and stored, using a particular spreadsheet application program), the web browser can be configured to open the file with the appropriate application program when the application program is available on the computing device operating the web browser.

The FTP and HTTP protocols along with advancements in computer operating systems and local area network (LAN) infrastructures have led to the proliferation of proprietary Intranets containing similar documents, associated files, scripts, subprocedures, databases, application software, etc. Whether the components are part of an Intranet or the publicly accessible Internet, the component parts are often modified. That is, databases are updated, application software revised, and documents are added or otherwise modified.

As described above, a common way to access web sites is via a web browser. There are times, however, when it is preferable to bypass the browser and access a web site with a program operable to communicate via HTTP. For example, automated web-site testing can be facilitated by accessing web-site content via an application, e.g., Xunit, HttpUnit, etc. that is configured to evaluate various functionality of the web site components as well as web site content and format.

HttpUnit emulates web browser behaviors, including form submission, JavaScript, HTTP authentication, cookies, automatic page redirection and the like. Furthermore, HttpUnit allows Java test code to examine returned pages either as text, as an extensible markup language (XML) document object model (DOM), or as containers of forms, tables, and links. HttpUnit is a free open-source Java application program interface (API) for accessing web sites without a web browser and is designed for facilitating automated unit testing of web sites when combined with a Java unit test engine such as Junit.

The core of HttpUnit is a “WebConversation” class that takes the place of a web browser communication with a single Internet-coupled web server. The WebConversation class comprises the context for a series of HTTP requests. Additionally, the WebConversation class manages cookies used to maintain session contexts, computes relative URLs, and generally emulates requisite web browser behavior for enabling an automated test of a web site. The WebConversation class is responsible for maintaining session context by managing cookies returned by the web server. To implement a WebConversation class, a request is generated by, and a response thereto is provided to, the WebConversation. The response may be manipulated either as pure text, as a DOM, or by one of various other well-known methods.

As described above, the most common form of navigating web pages is by links. HttpUnit allows users to find links by the text within them and uses the located links as new page requests. For example, a page may contain a link to a JavaDoc, a tool for generating HTML formatted API documentation, for a “WebResponse” class. The page containing the JavaDoc may therefore be obtained by initiating a WebConversation, obtaining a web response (e.g., a getResponse), and analyzing a link object obtained in the response. Image links and text can be analyzed according to this technique.

HttpUnit may be used to analyze various other page content in addition to text and links. For example, many web pages use tables to control page formatting. HttpUnit can be used to analyze tables by testing individual table elements. A “getTables” method may be invoked that returns an array of page tables ordered as located in the document. Contents of table cells may be retrieved and later analyzed as text or a DOM. Alternatively, table contents may be retrieved as other tables (i.e., nested tables), links, or forms nested within the retrieved table. Typically, a HttpUnit test verifies the table text rather than the formatting.

A dynamic web site may comprise a plurality of HTML forms each of which may comprise various controls; for example, text boxes, pull-down menus, radio control buttons, and/or other control elements. The HTML code for various controls available within a web page can vary significantly. To simplify analysis of the web page, however, HttpUnit modifies the HTML code to render the various controls uniform in appearance. A common test implemented by Http Unit is to verify HTML controls and the associated default values. Upon verification of a HTML control and an associated default value, a HttpUnit test may perform a form submission and analyze a system response thereto. Simulation of a form submission may be facilitated by calling a submit method.

HTML controls can include anchor, button, form, generic, image, inputbutton, inputcheckbox, inputfile, inputhidden, inputimage, inputradiobutton, inputtext, select, table, tablecell, tablerow, and textarea, among others. An anchor controls an<a> HTML element. A button controls a <button> HTML element. A form controls a <form> HTML element. Generic controls other HTML elements not specified by a special server control, such as<body>, <span>, etc. Image controls an<image> HTML element. Inputbutton controls input type “button,” “submit,” and “reset” HTML elements. Inputcheckbox controls an input type <checkbox> HTML element. Inputfile controls an input type <file> HTML element. Inputhidden controls an input type <hidden> HTML element. Inputimage controls an input type <image> HTML element. Inputradiobutton controls an input type <radio> HTML element. Inputtext controls input type <text> and input type <password> HTML elements. Select controls a <select> HTML element. Table controls a <table> HTML element. Tablecell controls <td> and <th> HTML elements. Tablerow controls a <tr> HTML element. Textarea controls a <textarea> HTML element.

Other web page content tests may be implemented by HttpUnit. For example, frame analysis may be performed by Http unit by initiating methods of the WebConversation class that examine active frames. A response to a frame submission may result in replacement of frame content.

Extensible markup language (XML) is a standard for creating markup languages. XML is a pared-down version of the Standard Generalized Markup Language (SGML), designed especially for web documents. XML allows designers to create their own customized tags, enabling the definition, transmission, validation, and interpretation of data between applications and between organizations.

Documents written in an XML language may be processed by a program without knowledge of the language itself. Prior to the development of generalized data description languages such as XML, it was necessary to define a file format and a corresponding special purpose parser or other application to interpret the language. XML, and other data description languages, allow software developers to specify fundamental language syntax by defining a document type definition (DTD) that specifies constraints on the document structure. A typical DTD employed for interpretation of an XML document specifies allowable XML elements, attributes, and attribute values. Alternatively, an XML schema may be defined.

A schema defines a richer set of data types, such as booleans, numbers, dates and times, and currencies. These richer data types are important components provided to programmers for enabling commercial transactions on the web. DTDs, on the other hand, express data types as explicit enumerations, which makes validation much more difficult and less accurate. An XML schema will also make it easier to validate documents based on namespaces (used to qualify element and attributes names by associating them with namespaces identified by Uniform Resource Identifiers (URI) references). Namespaces prevent identically custom-named tags that may be used in different XML documents from being read the same way). Conversely, DTDs using explicit enumerations treat identically named tags in the same manner.

An XML file is a text file that conforms to various XML syntax rules. For example, an XML document includes an identifier that specifies the document is an XML compliant file. The XML declaration may additionally identify an XML version and an encoding format. XML encoding generally defaults to 8-bit Unicode Transformation Format (UTF-8). An XML compliant document comprises a single root element and elements containing data entries that are delineated with an opening and a closing tag. Additionally, attribute values are delineated with quotations, and nested (but not overlapping) tags are permissible.

Conventionally, HttpUnit operates in accordance with test code generated for each specific HttpUnit test to be performed. That is, operators of HttpUnit must encode each test desired to be performed on a web site in accordance with the API.

### SUMMARY

A website test system includes an interface and a test engine. The interface receives a test specification encoded in an extensible markup language. The interface forwards the test specification to the test engine, which receives the test specification, identifies a source code of interest, establishes a communication session with a server hosting the source code of interest, and evaluates the source code in accordance with the test specification.

### BRIEF DESCRIPTION OF THE DRAWINGS

Embodiments of an interface and an automated test method are illustrated by way of example and are not limited by the implementations depicted in the following drawings. The components in the drawings are not necessarily drawn to scale. Emphasis instead is placed upon clearly illustrating the principles of the interface and the automated test method. Moreover, in the drawings, like reference numerals designate corresponding parts throughout the several views.

FIG. 1 is a schematic diagram illustrating an embodiment of an environment in which the interface resides.

FIG. 2 is a functional block diagram of an embodiment of the computing device(s) as shown in FIG. 1.

FIG. 3 is a schematic diagram of an embodiment of a network protocol stack that facilitates an automated web server test.

FIG. 4 is a schematic diagram of an embodiment of a test unit as shown in FIG. 2.

FIG. 5 is a flow diagram illustrating an embodiment of a method for directing an automated test.

### DETAILED DESCRIPTION

Embodiments of an interface provide a technique for defining tests using an XML source document. Accordingly, new tests and/or modified versions of previously submitted tests can be generated and submitted to HttpUnit and other similar test engines, rather than generating new test source code. In other words, an XML document is used to drive and define tests of web site and other application software performed by a test engine such as HttpUnit. The present system and method uses XML to define resources and provide data and instruction set for testing the resources. By using XML, no test code needs to be written to add new tests or to modify existing tests, etc.

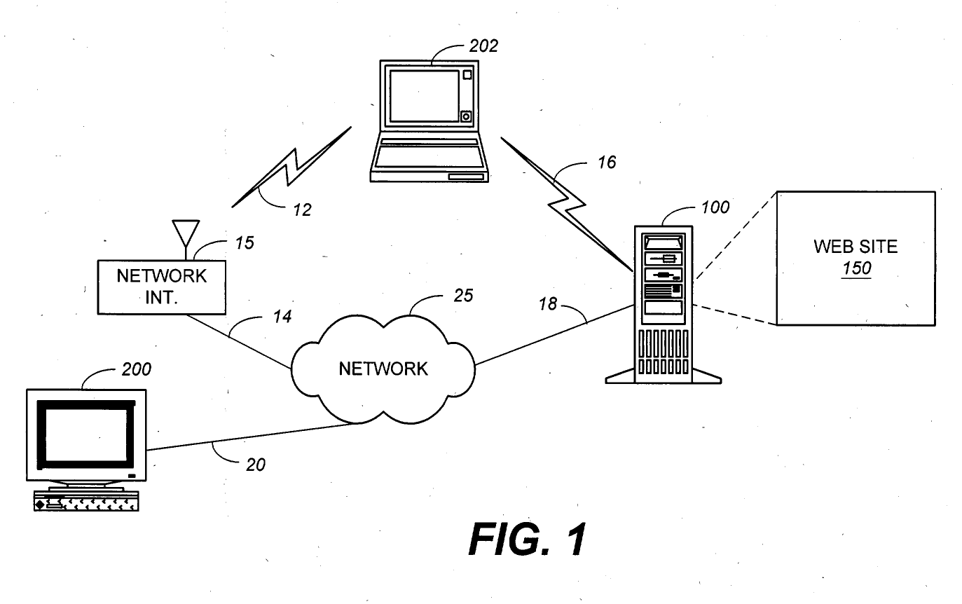

FIG. 1 is a schematic diagram illustrating an embodiment of an environment in which the interface resides. The interface is implemented primarily in software within a computer 200 coupled to web server 100 via network 25. The computer 200, which can be a personal computer (PC), a workstation, etc. is coupled to the computer 200 via connection 20, network 25, and connection 18. The network 25 may be a local area network (LAN), such as an office network, or may be a wide area network (WAN) such as the Internet. Furthermore, the network 25 may be a wireless network or as in the illustrated environment of FIG. 1, network 25 may contain both wireless and wired components. In the illustrated embodiment, computer 200 and the web server 100 are connected to network 25 via connections 20 and 18, respectively.

In an alternative embodiment, further illustrated in FIG. 1, the interface is implemented primarily in software within laptop computer 202 coupled to web server 100 via various wireless connections. In a direct communication mode, laptop computer 202 communicates with web server 100 via wireless connection 16. In an indirect communication mode, laptop computer 202 communicates with web server 100 via wireless connection 12, wireless network interface 15, connection 14, network 25, and connection 18.

Wireless communication links 12 and 16 can be infrared (IR) or radio-frequency (RF) links capable of transferring information from laptop computer 202 to each of the respective receiving devices (e.g. network interface 15). A variety of wireless communication interfaces and data transfer protocols support the communication of information from a portable device such as laptop computer 202 and an appropriately configured receiving device. For example, infrared data association protocol (IrDA), wireless fidelity (IEEE 802.11b wireless networking) or Wi-Fi, Bluetooth®, etc. each support wireless data transfers. Bluetooth® is the registered trademark of Bluetooth SIG, Inc.

Computer 200 may be a personal computer located at, for example, a business office, and connection 20 can be any connection for coupling the computer 200 to network 25. In a typical implementation, network 25 is the publicly accessible WAN commonly known as the Internet, and connection 20 is one of a dial-up connection, a broadband connection, such as a digital subscriber line (DSL), or another high-speed connection, such as a Ti connection.

The web server 100 is generally a dedicated computing device coupled to network 25 via a high-speed connection 18 that maintains, operates, or is otherwise coupled to a world wide web (WWW) location such as web site 150. In the illustrated embodiment, web server 100 maintains and operates web site 150. As described above, web site 150 is a related group of documents, associated files, scripts, subprocedures, databases, application software, and/or images, etc. Web site 150 is accessible via computer 200 and laptop computer 202 using HTTP, FTP, among other communication protocols. While illustrated as only two computers (i.e., computer 200 and laptop computer 202) coupled to web server 100 via network 25 and the various wireless and wired connections, many additional computers and server computers may be coupled to network 25.

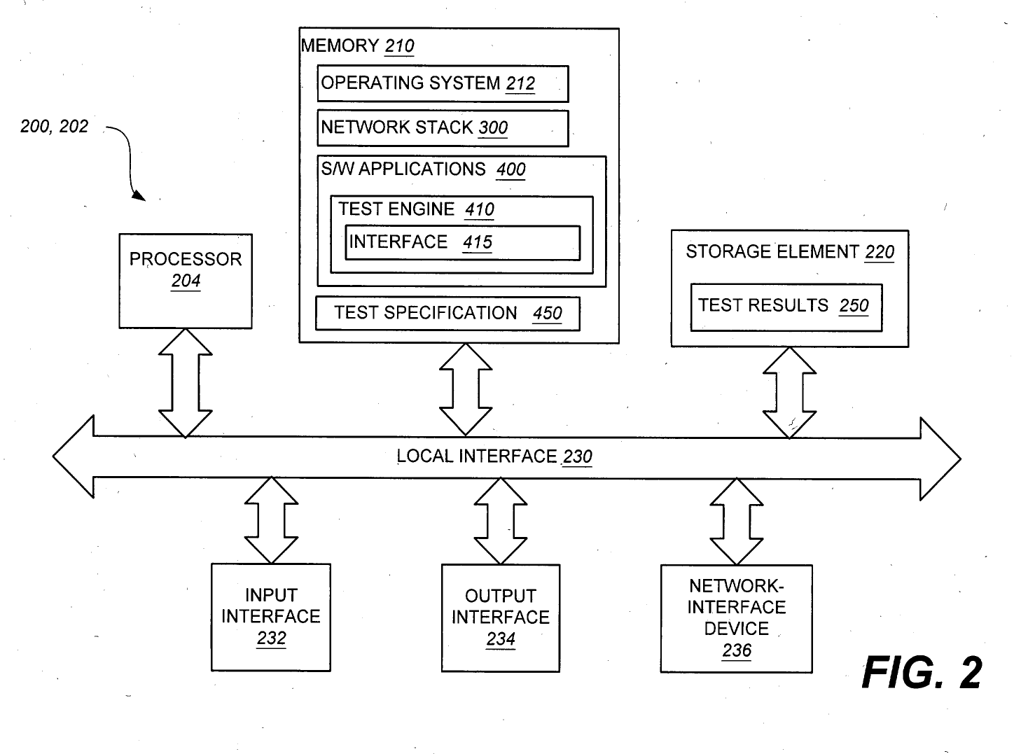

FIG. 2 is a functional block diagram of an embodiment of the general architecture of computer 200 and laptop computer 202 of FIG. 1. Computer 200 and laptop computer 202 include a processor 204, a memory 210, a storage element 220, an input interface 232, an output interface 234, and a network interface device 236 that are communicatively coupled via local interface 230.

Local interface 230 can be, for example, but not limited to, one or more buses or other wired or wireless connections, as is known in the art or may be later developed. Local interface 230 may have additional elements, which are omitted for simplicity, such as controllers, buffers (caches), drivers, repeaters, and receivers, to enable communications. Further, local interface 230 may include address, control, and/or data connections to enable appropriate communications among the aforementioned components of the computer 200 or the laptop computer 202.

In the embodiment of FIG. 2, the processor 204 is a hardware device for executing software that can be stored in memory 210. The processor 204 can be a custom-made or commercially-available processor, a central-processing unit (CPU) or an auxiliary processor among several processors associated with the computer 200 or the laptop computer 202.

The memory 210 can include any one or combination of volatile memory elements (e.g., random-access memory (RAM, such as dynamic-RAM or DRAM, static-RAM or SRAM, etc.)) and nonvolatile-memory elements (e.g., read-only memory (ROM), hard drives, tape drives, compact-disk drives (CD-ROMs), etc.). Moreover, the memory 210 may incorporate electronic, magnetic, optical, and/or other types of storage media now known or later developed. Note that the memory 210 can have a distributed architecture, where various components are situated remote from one another, but accessible by processor 204.

The software in memory 210 may include one or more separate programs, each of which comprises an ordered listing of executable instructions for implementing logical functions. In the example of FIG. 2, the software in the memory 210 includes software applications 400, which further include test engine 410. Software applications 400, including test engine 410, function as a result of and in accordance with operating system 212. Software applications 400 can include one or more commercially available applications as well as proprietary applications. As described above, the applications may be used as part of a process initiated by one or more computing devices such as computer 200 and laptop computer 202 for accessing and interacting with web content and web site components via network 25 (FIG. 1) or a wireless connection.

Operating system 212 preferably controls the execution of computer programs, such as software applications 400 and provides scheduling, input-output control, file and data management, memory management, and communication control and related services.

In an embodiment, test engine 410 includes one or more source programs, executable programs (object code), scripts, or other collections, each comprising a set of executable instructions to be performed. As shown in FIG. 2, test engine 410 is configured with a interface 415 which is configured to receive a test specification 450 encoded in an extensible markup language. In the embodiment illustrated in FIG. 2, test specification 450 is located within memory 210 and test results 250, generated by test engine 410, are stored in storage element 220. In alternative embodiments, test specification 450 can be located within storage element 220 and/or other data storage devices communicatively coupled and accessible by processor 204. Similarly, test results 250 can be saved or otherwise stored in one or more data storage devices communicatively coupled to and accessible by processor 204.

As further illustrated in FIG. 2, the computing devices are configured with an input interface 232, an output interface 234, and a network interface device 236. Input interface 232 is configured to operate various operator-machine interfaces such as, but not limited to, a keyboard, a mouse (or other interactive-pointing devices), voice-activated interfaces, or other interfaces now known or later developed. Input interface 232 is in communication with the processor 204 via local interface 230.

Output interface 234 may include a video interface that supplies a video-output signal to a display associated with the respective computing device. Display devices that can be associated with the computer 200 and/or the laptop computer 202 are conventional CRT based displays, liquid-crystal displays (LCDs), plasma displays, image projectors, or other display types now known or later developed. It should be understood that various other output devices in addition to those described above may also be integrated via local interface 230 and/or other interfaces to other peripheral devices such as plotters, printers, copiers, etc.

Network interface device 236 can include an IR port and/or a RF port along with various wired ports such as an Ethernet port (not shown for simplicity of illustration). Regardless of the network interface medium, network interface device 236 communicates with the processor 204 via local interface 230 and external network coupled devices using an appropriate data transfer protocol. One or more of the network coupled devices will be communicatively coupled to network 25 (FIG. 1).

When the computing devices are in operation, the processor 204 is configured to execute software stored within the memory 210, to communicate data to and from the memory 210, and to generally control operations of the computer 200 or the laptop 202 pursuant to the software. The operating system 212, software applications 400, including test engine 410, in whole or in part, but typically the latter, are read by the processor 204, perhaps buffered within the processor 204, and then executed.

It should be understood that the test engine 410 and interface 415 can be embodied in any computer-readable medium for use by or in connection with an instruction-execution system, apparatus, or device, such as a computer-based system, processor-containing system, or other system that can fetch the instructions from the instruction-execution system, apparatus, or device, and execute the instructions. In the context of this disclosure, a “computer-readable medium” can be any means that can store, communicate, propagate, or transport a program for use by or in connection with the instruction-execution system, apparatus, or device. The computer-readable medium can be, for example but not limited to, an electronic, magnetic, optical, electromagnetic, infrared, or semiconductor system, apparatus, device, or propagation medium now known or later developed. Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Those skilled in the art will understand that various portions of the test engine 410 and the interface 415 can be implemented in hardware, software, firmware, or combinations thereof. In separate embodiments, the test engine 410 and the interface 415 are implemented using a combination of hardware and software or firmware that is stored in memory and executed by a suitable instruction-execution system. If implemented solely in hardware, as in an alternative embodiments, the test engine 410 and the interface 415 can be separately implemented with any or a combination of technologies which are well-known in the art (e.g., discrete-logic circuits, application-specific integrated circuits (ASICs), programmable-gate arrays (PGAs), field-programmable gate arrays (FPGAs), etc.), and/or later developed technologies. In preferred embodiments, the functions of the test engine 410 and the interface 415 are implemented in a combination of software and data executed and stored under the control of the computer 200 and/or laptop computer 202, respectively. It should be noted, however, that neither the test engine 410 nor the interface 415 are dependent upon the nature of the underlying computing device and/or upon the operating system in order to accomplish their respective designated functions.

It will be well understood by one having ordinary skill in the art, after having become familiar with the teachings of the test engine 410, the interface 415 and the automated testing methods, that s/w applications 400, the test engine 410, and the interface 415 may be written in a number of programming languages now known or later developed.

In the context of the present application software, the processor 204 executes an instance of the test engine 410, e.g., HttpUnit, in memory 210. Using conventional techniques under the direction of operating system 212, the various executable instructions within test engine 410 direct the processor 204 to communicate with web server 100 via network interface device 236.

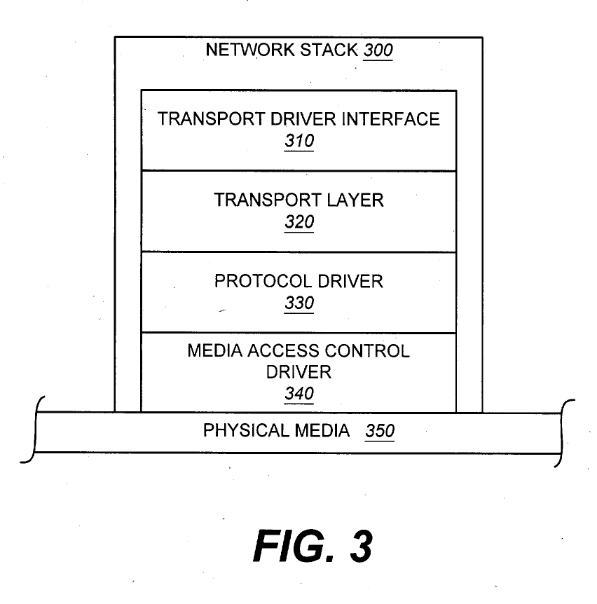

Operating system 212 preferably comprises, or alternatively interfaces with, a network protocol stack that defines the entry point for HTML encoded data received from a node, such as web server 100 via network 25. Network stack 300 is illustrated in FIG. 3 to facilitate an understanding of the interface 415. However, it should be understood that the interface 415 is not limited to the implementation illustrated in FIG. 3.

Network stack 300 includes a transport driver interface 310, a transport layer 320, a protocol driver 330, and a media access control driver 340. The media access control driver 340 interfaces with physical media 350 to facilitate an automated web server test under the direction of test engine 410. Transport driver interface 310 integrates the transport layer 320 with higher-level file-system drivers. Accordingly, transport driver interface 310 enables operating system drivers, such as network redirectors, to activate a session, or bind with the appropriate protocol driver 330. In this way, a redirector can access the appropriate protocol, for example, user data protocol (UDP), TCP, netbios extended user interface (NetBEUI) among other network or transport layer protocols, thereby making the redirector protocol independent.

The protocol driver 330 creates data packets that are sent from the computing system (e.g., computer 200 and/or laptop computer 202) hosting the network stack 300 to another computer, such as web server 100 via physical media 350 associated with network 25. Typical protocols supported by network stack 300 include NetBEUI, TCP/IP, NWLink, Data Link Control (DLC) and Appletalk®, among other transport and network protocols. Appletalk® is a registered trademark of Apple Computer, Inc., of Cupertino, Calif., U.S.A. Media access control driver 340, for example, an Ethernet driver, a token ring driver or other networking driver, provides appropriate formatting and interfacing with the physical media 350, such as category 5 wiring, a coaxial cable or some other medium.

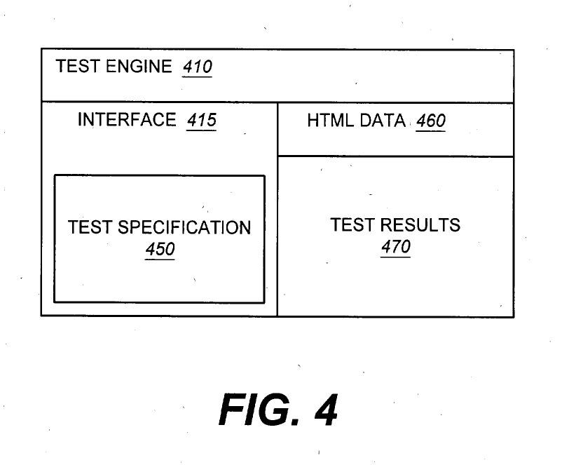

FIG. 4 is a schematic diagram of an embodiment of the test engine 410 of FIG. 2. As illustrated, a test specification 450 is encoded in an extensible markup language and forwarded to test engine 410. Interface 415 receives the test specification 450 and converts the encoded data therein into an instruction set that is recognized by test engine 410. Test engine 410 may be invoked by an operator of the computing device, and test specification 450 may be identified as an input thereto. The instruction set encoded with test specification 450 defines one or more unit tests, and identifies, for example, via a uniform resource locator, one or more web servers, such as web server 100. In addition, the instruction set may define one or more portions of source code of interest. Test engine 410, in accordance with the instruction set may retrieve HTML encoded data from the identified source by interfacing with the source via network stack 300, e.g., by using a WebConversation class and an HTTP session to establish a communication session with web server 100.

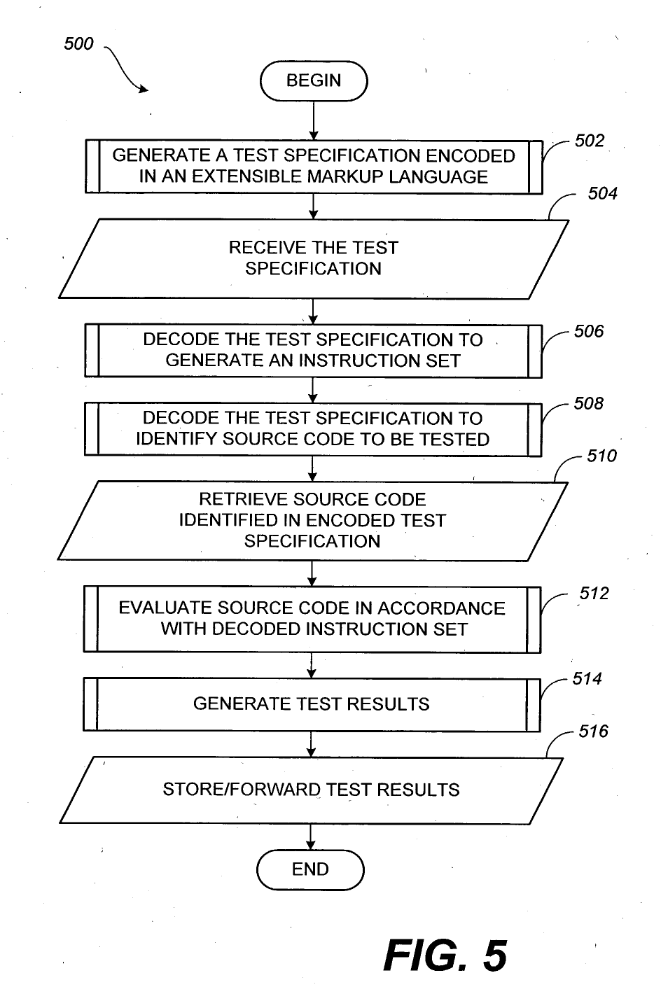

Process descriptions or blocks in the flow diagram presented in FIG. 5 should be understood to represent modules, segments, or portions of code or logic, which include one or more executable instructions for implementing specific logical functions or blocks in the associated process. Alternate implementations are included within the scope of the present test engine interface and automated test method in which functions may be executed out of order from that shown or discussed, including substantially concurrently or in reverse order, depending on the functionality involved, as would be understood by those reasonably skilled in the art after having become familiar with the teachings of the present apparatus and method.

Reference is now directed to FIG. 5, which presents an embodiment of a method for automatically testing a web site. Method 500 begins with block 502 where a test engineer or other operator generates a test specification encoded in an extensile markup language. Test engine 410 receives the test specification as indicated in block 504. Thereafter, as illustrated in blocks 506 and 508 the test specification is decoded to generate an instruction set and to identify source code to be tested, respectively.

Next, as indicated in block 510, test engine 410 retrieves the source code identified in the instruction set. The test engine 410 then evaluates the source code in accordance with the instruction set as indicated in block 512. Test engine 410 may generate test results 514 and store and/or otherwise forward the test results as indicated in block 516.

We claim:

1. A computer-readable medium having stored thereon an executable instruction set, the instruction set, when executed by a processor, directs the processor to perform a method comprising:
receiving a test specification comprising an instruction set encoded in an extensible markup language;
identifying a source code of interest; and
evaluating the source code in accordance with the instruction set.

2. The computer-readable medium of claim 1, wherein identifying a source code of interest further comprises identifying a hypertext markup language source code.

3. The computer-readable medium of claim 1, wherein identifying a source code of interest further comprises performing a direct call to the source code in accordance with the instruction set.

4. The computer-readable medium of claim 1, wherein evaluating the source code further comprises initiating a webconversation class with a host of the source code.

5. The computer-readable medium of claim 4, wherein evaluating the source code further comprises:
generating a request to a resource hosting the source code; and
receiving a response to the request.

6. The computer-readable medium of claim 5, wherein evaluating the source code further comprises:
generating a test result in accordance with the response.

7. The computer-readable medium of claim 6, wherein the response comprises a hypertext markup language encoded control object.

8. The computer-readable medium of claim 1, further comprising:
retrieving the source code of interest from a host; and
decoding the source code.

9. A method for testing a website, comprising:
providing a test specification encoded in an extensible markup language to a test engine;
retrieving, by the test engine, a source code of interest; and
evaluating, by the test engine, the source code in accordance with the test specification.

10. The method of claim 9, further comprising:
establishing a communication session between the test engine and a server hosting the source code of interest.

11. The method of claim 9, wherein retrieving a source code further comprises initiating a webconversation class with a server hosting the source code of interest.

12. The method of claim 9, wherein retrieving a source code of interest further comprises:
submitting a request to a server hosting the source code; and
receiving a response to the request.

13. The method of claim 9, wherein retrieving a source code of interest further comprises retrieving a document control encoded in hypertext markup language.

14. The method of claim 9, wherein retrieving a source code of interest further comprises retrieving a hypertext markup language control selected from the group consisting of anchor, button, form, generic, image, inputbutton, inputcheckbox, inputfile, inputhidden, inputimage, inputradiobutton, inputtext, select, table, tablecell, tablerow, and textarea.

15. The method of claim 9, wherein evaluating the source code further comprises analyzing the source code as text.

16. The method of claim 9, wherein evaluating the source code further comprises analyzing the source code as a document object model.

17. An automated website test system, comprising:
an interface configured to receive a test specification encoded in an extensible markup language;
a test engine coupled to the interface, the test engine configured to:
receive the test specification;
identify a source code of interest;
establish a communication session with a server hosting the source code of interest; and
evaluate the source code in accordance with the test specification.

18. The system of claim 17, wherein the test engine evaluates the source code of interest by:
generating a request to the server; and
receiving a response to the request.

19. The system of claim 18, wherein the test engine evaluates the source code of interest by:
generating a test result in accordance with the response.

20. The system of claim 18, wherein the response comprises a hypertext markup language encoded control object.

21. An automated website test system, comprising:
means for receiving a test specification encoded in an extensible markup language;
means for identifying a source code of interest responsive to the test specification;
means for establishing a communication session with a server hosting the source code of interest; and
means for evaluating the source code of interest in accordance with the test specification.

22. The system of claim 21, wherein the means for evaluating the source code of interest further comprises:
means for generating a request to the server; and
means for receiving a response to the request.

23. The system of claim 21, wherein the means for evaluating the source code of interest comprises means for generating a test result in accordance with the response.

24. The system of claim 24, wherein the means for evaluating the source code of interest comprises a hypertext markup language encoded control object.
